(19) United States
(12) Patent Application Publication
(10) Pub. No.: US 2004/0202213 A1
(43) Pub. Date: Oct. 14, 2004

(54) Semiconductor optical package

(76) Inventors: In-Kuk Yun, Suwon-si (KR); Jeong-Seok Lee, Anyang-si (KR); Ho-In Kim, Yongin-si (KR); Hyun-Cheol Shin, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/839,304

(22) Filed: May 5, 2004

(30) Foreign Application Priority Data
Jan. 15, 2003 (KR) 2004-3064

(51) Int. Cl. H01S 3/04; H01S 3/08

(52) U.S. Cl. 372/36

(57) ABSTRACT

A semiconductor optical package having a TO-can structure including a housing and a stem accommodated in the housing is disclosed. The semiconductor optical package includes a sub-mount mounted on the stem, and a reflective semiconductor optical amplifier having first and second ends, through which light is input and output The optical amplifier also includes an active layer extending by a predetermined length while being inclined at a predetermined angle with respect to an axis perpendicular to the first and second ends. The reflective semiconductor optical amplifier amplifies light input through the first end and rests on the sub-mount in such a manner that an axis of light, which is input or output through the first and second ends, respectively, is perpendicular to both ends of the sub-mount.

### CLAIM OF PRIORITY

This application claims priority to an application entitled “Semiconductor optical package,” filed in the Korean Intellectual Property Office on Jan. 15, 2004 and assigned Serial No. 2004-03064, the contents of which are hereby incorporated by reference.

### BACKGROUND OF THE INVENTION

1. Field of the Invention

The present invention relates to a semiconductor optical package, and more particularly to a semiconductor optical package having a TO-can structure.

2. Description of the Related Art

A structure of a conventional semiconductor optical package 100 is shown in FIG. 1. The conventional semiconductor optical package 100 includes a housing 101 having a TO-can structure, a reflective semiconductor optical amplifier 110 for generating and amplifying light having a predetermined wavelength, a photo diode 130 for monitoring intensity of light output from the reflective semiconductor optical amplifier 110, and a stem 120.

The reflective semiconductor optical amplifier 110 has a first end 110a coated with an anti-reflective layer and a second end 110b coated with a high-reflective layer. This increases the amplification efficiency of light input into the reflective semiconductor optical amplifier 110 or the output efficiency of light generated in the reflective semiconductor optical amplifier 110. The reflective semiconductor optical amplifier 110 also has an active layer 111 extending from the first end 110a to the second end 110b while being inclined at a predetermined angle with respect to a predetermined axis perpendicular to the first and second ends 110a and 110b.

The stem 120 rests on a bottom surface of the housing 101 in order to support the reflective semiconductor optical amplifier 110. The stem 120 is formed at one side portion thereof with an inclined surface in such a manner that the first end 110a of the reflective semiconductor optical amplifier 110 is inclined with respect to an optical axis.

The semiconductor optical package as shown in FIG. 1 is disclosed in U.S. Pat. No. 6,314,117, which is issued to Quan Photonics, Inc. on Nov. 6, 2001 and titled “Laser diode package”.

However, in the conventional semiconductor optical package described above, a waveguide of the reflective semiconductor optical amplifier must match with one side of the stem while being inclined with respect to a predetermined axis perpendicular to both ends of the reflective semiconductor optical amplifier. This requires that the stem be separately manufactured according to characteristics of the reflective semiconductor optical amplifier.

This is a significant shortcoming because it adds manufacture cost and increases the complexity of the manufacturing process.

### SUMMARY OF THE INVENTION

One aspect of the present invention is to provide a semiconductor optical package capable of easily carrying out an optical axis alignment of a reflective semiconductor optical amplifier including a waveguide, which is inclined lengthwise to the reflective semiconductor optical amplifier as compared to the conventional semiconductor optical packages.

One embodiment of the present invention is directed to a semiconductor optical package having a TO-can structure including a housing and a stem accommodated in the housing. The semiconductor optical package includes a sub-mount mounted on the stem and a reflective semiconductor optical amplifier having first and second ends through which light is input and output. The semiconductor optical amplifier also includes an active layer extending a predetermined length while being inclined at a predetermined angle with respect to an axis perpendicular to the first and second ends. The reflective semiconductor optical amplifier amplifies light input through the first end and is rests on the sub-mount in such a manner that an axis of light input and output through the first and second ends is perpendicular to both ends of the sub-mount.

### BRIEF DESCRIPTION OF THE DRAWINGS

The above aspects, features and embodiments of the present invention will be more apparent from the following detailed description taken in conjunction with the accompanying drawings, in which:

FIG. 1 is a diagram showing the structure of a conventional semiconductor optical package;

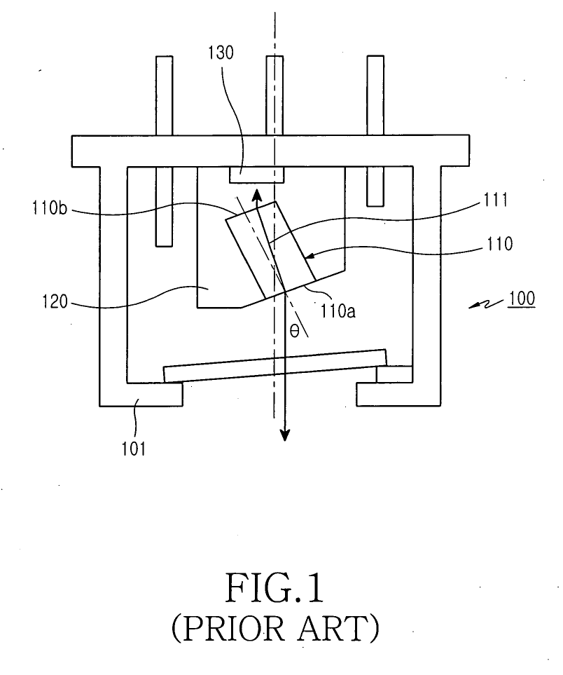

FIG. 2 is a diagram showing the structure of a semiconductor optical package according to a first embodiment of the present invention; and

FIG. 3 is a diagram showing the structure of a semiconductor optical package according to a second embodiment of the present invention.

### DETAILED DESCRIPTION

Hereinafter, embodiments of the present invention will be described with reference to the accompanying drawings. In the following description and drawings, the same reference numerals are used to designate the same or similar components, and so repetition of the description on the same or similar components will be omitted.

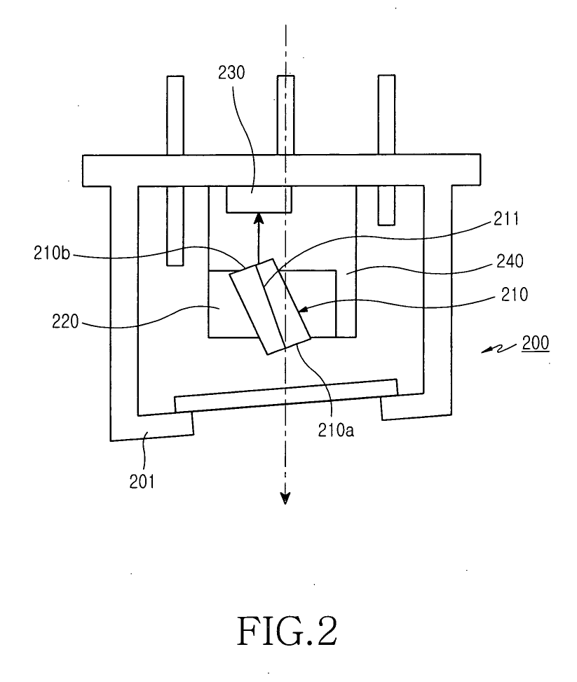

FIG. 2 is a diagram showing the structure of a semiconductor optical package 200 according to a first embodiment of the present invention. The semiconductor optical package 200 includes a housing 201, a stem 240 accommodated in the housing 201, a sub-mount 220 resting on the stem 240, a reflective semiconductor optical amplifier 210 having first and second ends 210a and 210b for inputting/outputting light and an active layer 211 extending by a predetermined length while forming a predetermined angle with respect to an axis perpendicular to the first end 210a and the second end 210b. The semiconductor optical package also includes a photo diode 230 located on a bottom surface of the housing 201 in such a manner that the active layer 211 is opposed to the second end 210b of the reflective semiconductor optical amplifier 210 in order to detect intensity of light generated from the reflective semiconductor optical amplifier 210.

The reflective semiconductor optical amplifier 210 is rests on the sub-mount 220 in such a manner that an optical axis of light input or output through the first end 210a or the second end 210b, respectively, is substantially perpendicular to one or both ends of the sub-mount 220.

Also, the sub-mount 220, on which the reflective semiconductor optical amplifier 210 is slantingly rested, is installed to match with an edge of the stem 240. In this way, the reflective semiconductor optical amplifier 210 is aligned in such a manner that the optical axis of light input through the first end 210a is located at a center of the semiconductor optical package 200.

As a result, the sub-mount 220 formed thereon with the reflective semiconductor optical amplifier 210 matches with one side of the stem 240 so that a lens system can be located at a predetermined location, and a location of the photo diode 230 opposed to the second end 210b can correctly be detected.

The reflective semiconductor optical amplifier 210 includes the active layer 211 formed on a semiconductor substrate (not shown). The active layer 211 is surrounded by an upper clad or a lower clad (not shown) so that created light or amplified light can be output. In addition, an anti-reflective layer is coated on the first end 210a, into which light is input, of the reflective semiconductor optical amplifier 210. Also, a high reflective layer is coated on the second end 210b, through which light is output, in order to reflect the created or amplified light towards the first end 210a. This improves the amplification efficiency as well as input/output efficiency. The active layer 211 extends from the first end 210a to the second end 210b in such a manner that the active layer 211 is inclined at a predetermined angle with respect to the axis perpendicular to the first end 210a and the second end 210b.

It is noted, however, that the high reflective layer coated on the second end 201b cannot completely reflect the light output from the active layer 211 to the first end 210a. This means that a part of light is transmitted through the high reflective layer. The photo diode 230 detects light, which has been transmitted through the second end 210b, in order to monitor the intensity of light generated from the reflective semiconductor optical amplifier 210.

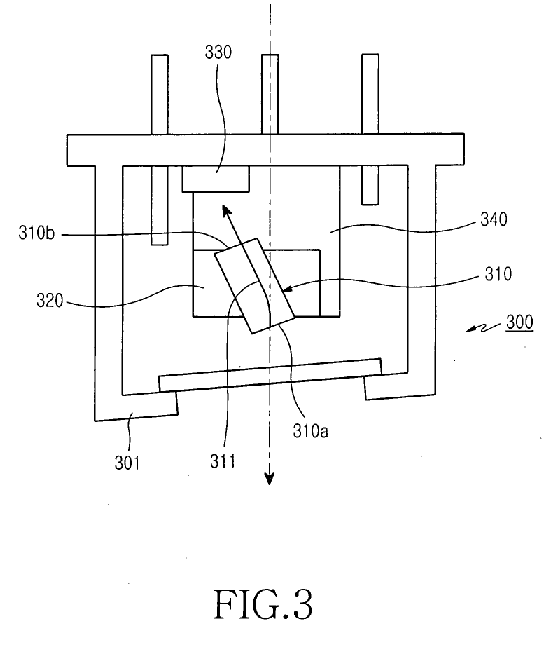

FIG. 3 is a diagram showing a structure of a semiconductor optical package 300 according to a second embodiment of the present invention. The semiconductor optical package 300 includes a housing 301, a stem 340 accommodated in the housing 301, a sub-mount 320 resting on the stem 340, and a reflective semiconductor optical amplifier 310 having a first end 310a and a second end 310b for inputting and outputting light. The semiconductor optical package 300 also includes a photo diode 230 resting on a bottom surface of the housing 301 in order to detect intensity of light transmitted through the second end 310b of the reflective semiconductor optical amplifier 310. In this embodiment, parts and functions identical to those of the above-described first embodiment will be omitted in order to avoid redundancy.

The semiconductor optical amplifier 310 generates light and an active layer 311 extends from the first end 310a to the second end 310b in a curved shape so as to guide light generated from the semiconductor optical amplifier 310.

This structure allows for easy alignment, as compared to conventional devices discussed above, of an optical axis of the reflective semiconductor optical amplifier 310 including the waveguide vertically inclined with respect to an axis of first and second ends of the reflective semiconductor optical amplifier 310. Also, it is possible to directly align the reflective semiconductor optical amplifier 310 on the stem 340, which is not inclined, after manually aligning the reflective semiconductor optical amplifier 310 on the sub-mount 320. In this way, the semiconductor optical package 300 can be easily manufactured as compared with the conventional semiconductor optical package having an inclined stem. Also, the semiconductor optical amplifier 310 can be used in various semiconductor optical packages regardless of the shapes of the stem.

Although various embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A semiconductor optical package having a TO-can structure including a housing and a stem accommodated in the housing, the semiconductor optical package comprising:
a sub-mount having a top and bottom, the sub-mount being mounted on the stem; and
a reflective semiconductor optical amplifier having first and second ends, through which light is input and output, respectively, and an active layer extending by a predetermined length while being inclined at a predetermined angle with respect to an axis perpendicular to the first and second ends,
wherein the reflective semiconductor optical amplifier amplifies light input through the first end and rests on the sub-mount in such a manner that an axis of light input and output through the first and second ends, respectively, is substantially perpendicular to the top and bottom of the sub-mount.

2. The semiconductor optical package according to claim 1, further comprising a photo diode located on a bottom surface of the housing in such a manner that the photo diode is opposed to the second end of the reflective semiconductor optical amplifier in order to detect intensity of light generated from the semiconductor optical amplifier.

3. The semiconductor optical package according to claim 1, wherein the semiconductor optical amplifier generates light and the active layer extends from the first end to the second end while being inclined at a predetermined angle with respect to an axis perpendicular to the first end and the second end.

4. The semiconductor optical package according to claim 1, wherein the semiconductor optical amplifier generates light and the active layer extends from the first end to the second end in a curved shape so as to guide light generated from the semiconductor optical amplifier.

5. A semiconductor optical package having a TO-can structure, comprising:
a housing;
a stem accommodated in the housing, the stem having a top surface;
a reflective semiconductor optical amplifier, accommodated in the stem, having first and second ends, through which light is input and output, respectively, and an active layer being inclined at a predetermined angle with respect to an axis perpendicular to the first and second ends; and
a sub-mount having a surface, the surface positioned next to the top surface of the stem,
wherein the reflective semiconductor optical amplifier amplifies is positioned by the sub-mount in such a manner that an axis of light input through the first end is substantially perpendicular to the surface of the sub-mount.

6. The semiconductor optical package according to claim 5, further comprising a photo diode located on a bottom surface of the housing in such a manner that the photo diode is opposed to the second end of the reflective semiconductor optical amplifier in order to detect intensity of light generated from the semiconductor optical amplifier.

7. The semiconductor optical package according to claim 5, wherein the semiconductor optical amplifier generates light and the active layer extends from the first end to the second end while being inclined at a predetermined angle with respect to an axis perpendicular to the first end and the second end.

8. The semiconductor optical package according to claim 5, wherein the semiconductor optical amplifier generates light and the active layer extends from the first end to the second end in a curved shape so as to guide light generated from the semiconductor optical amplifier.
